(19) United States
(12) Patent Application Publication
(10) Pub. No.: US 2009/0031926 A1
(43) Pub. Date: Feb. 5, 2009

(54) ROTARY TABLE

(76) Inventor: Mamoru Goda, Osaka-fu (JP)

Correspondence Address: DUANE MORRIS LLP - Philadelphia;IP DEPARTMENT, 30 SOUTH 17TH STREET, PHILADELPHIA, PA, 19103-4196, US

(21) Appl. No.: 11/817,242

(22) PCT Filed: Feb. 28, 2005
(86) PCT No.: PCT/JP2005/003300

§ 371 Date: Aug. 28, 2007

(51) Int. Cl. A47B 11/00; F16M 11/08

(52) U.S. Cl. 108/22; 108/94

(57) ABSTRACT

A first rotating plate 10 is supported on a planar base plate 4 in such a manner as to be rotatable about a spindle 8. The first rotating plate 10 has a spar gear 30 disposed along its outer periphery to which driving force for rotating the first rotating plate 10 about the spindle 8. The first rotating plate 10 has first attachment parts 40a and 40b on its top surface for attachment to a television receiver. A second rotating plate 42 is detachably attached to the first rotating plate 10. The attachment of the second rotating plate 42 is such as to permit the second rotating plate 42 to slip about the spindle 8 relative to the first rotating plate 10 when force greater than a predetermined magnitude is exerted to the second rotating plate. The second rotating plate 42 has a second attachment part 54 on its top surface for attachment to a television receiver.

### TECHNICAL FIELD

This invention relates to a rotary table for rotating an article resting thereon and, more particularly, to such rotary table which can be driven either manually or mechanically.

### BACKGROUND

A rotary table is sometimes used for rotating a television receiver, for example. An example of such rotary table is disclosed in Patent Literature 1. The rotary table disclosed in Patent Literature 1 is rotated from driving force given by a motor. When a load is given to the television receiver while it is being rotated by the rotary table, slippage is generated to thereby prevent the television receiver from rotating further.

[Patent Literature 1] JP 07-231415 A

### DISCLOSURE OF THE INVENTION

### Problem to be Solved by the Invention

When, for example, a child is sandwiched between the television receiver and a wall while the television receiver is rotated on the rotary table disclosed in this Patent Literature 1, it is possible to prevent the child from being injured. This rotary table is what is called a mechanically driven table, which is driven from driving force given by an electrical motor. There is also a manual type rotary table which is driven manually. A mechanical rotary table requires a slippage generating mechanism, whereas a manual rotary table does not. Accordingly, mechanically driven rotary tables and manually driven rotary tables are separately manufactured, which increases the costs of the rotary tables.

An object of the present invention is to provide a rotary table which can be driven either mechanically or manually, and, when it is used as a mechanically driven rotary table, it is provided with a slippage mechanism.

### Means to Solve the Problem

A rotary table according to the present invention includes a planar base plate. A first rotating plate is supported on the base plate in such a manner as to be rotatable about an axis perpendicular to the base plate. The first rotating plate has a driving force transmitting part by which driving force for rotating the first rotating plate about the axis is transmitted. The first rotating plate has gear, for example, acting as the driving force transmitting part. The gear may be formed to extend along the outer periphery of the rotary table. The first rotating plate has a first attachment part for attaching the first rotating plate to an article to be rotated, e.g. a television receiver. A second rotating plate is detachably attached to the first rotating plate. The attachment is such as to permit the second rotating plate to rotate about the axis relative to the first rotating plate when force of a magnitude greater than a predetermined force is applied to the second rotating plate. The second rotating plate has a second attachment part for attachment to the article to be rotated.

When the rotary table with the above-described arrangement is to be used as a mechanically driven rotary table, an article to be rotated is attached to the second rotating plate with the second attachment part, and power is externally applied to the driving force transmitting part of the first rotating plate. This causes the second rotating plate to rotate, resulting in revolution of the article to be rotated. The second rotary table rotates relative to the first rotating plate when force of a magnitude larger than a predetermined value is exerted to the second rotating plate, and therefore the second rotating plate slips relative to the first rotating plate if and when, for example, a human is sandwiched between the article to be rotated and a wall. In other words, in this case, while the first rotating plate rotates, the second rotating plate does not and, therefore the article to be rotated does not rotate any more, either. When this rotary table is used as a manually driven rotary table, the second rotating plate is removed from the table, and the article to be rotated is attached to the first rotating plate with the first attachment part. The article to be rotated rotates when the first rotating plate is manually rotated. Like this, the rotary table with this arrangement can be used either as a manually driven rotary table or a mechanically driven rotary table, by attaching or detaching the second rotating plate. In addition, since the second rotating plate can be slipped relative to the first rotating plate when the rotary table is used as a mechanically driven rotary table, safety of the rotary table can be secured.

The attachment of the second rotating plate to the first rotating plate may be done by disposing the second rotating plate on the top surface of the first rotating plate, and by detachably fixing, to the first rotating plate, an pressing member, which extends from the first rotating plate onto the periphery of the second rotating plate. The pressing member may be provided for either one or both of the outer and inner peripheries of the second rotating plate. The pressing member may be ring-shaped so as to be able to contact the entire area of the peripheral portion of the second rotating plate. Alternatively, the pressing member may be formed of a plural pieces disposed at predetermined angles along the periphery of the second rotating plate.

With this arrangement, the second rotating plate is pressed against the first rotating plate by means of the pressing member, and therefore they are in friction-contact with each other with friction force generated between the first and second rotating plates, Accordingly, unless force larger than the friction force is exerted to the second rotating plate, the second rotating plate rotates with the first rotating plate. However, if force larger than the friction force is applied to the second rotating plate, the first rotating plate continues rotating, but the second rotating plate stops rotating. By virtue of this arrangement, although this rotary table can be either manually or mechanically driven, its safety can be secured even when it is used as a mechanically driven rotary table, and, still, the structure is simple.

The second rotating plate may be placed in a recess formed in the top surface of the first rotating plate. With this arrangement, the height of the rotary table can be small so that the rotary table can be thin.

The first attachment part may be disposed coplanar with the second rotating plate, and the pressing member can be mounted to the first attachment part. With this arrangement, when the rotary table is used as a mechanically driven rotary table, the first attachment part can be used for attaching the second rotating plate to the first rotating plate, and, when the rotary table is used as a manually driven rotary table, the first attachment member can be used for mounting the article to be rotated onto the rotary table. Thus, no separate attachment member is required for the attachment of the second rotating plate, so that the arrangement of the rotary table can be simplified.

### ADVANTAGES OF THE INVENTION

As described above, according to the present invention, a rotary table is provided, which can be used as either a mechanically driven rotary table or a manually driven rotary table, and which can secure its safety, when used as a mechanically driven rotary table, as a rotary table dedicatedly manufactured to be mechanically driven.

### BRIEF DESCRIPTION OF THE DRAWINGS

FIG. 1 is a longitudinal cross-sectional view of a rotary table according to one embodiment of the present invention when used as a mechanically driven rotary table.

FIG. 2 is a plan view of the rotary table of FIG. 1 with some parts thereof removed.

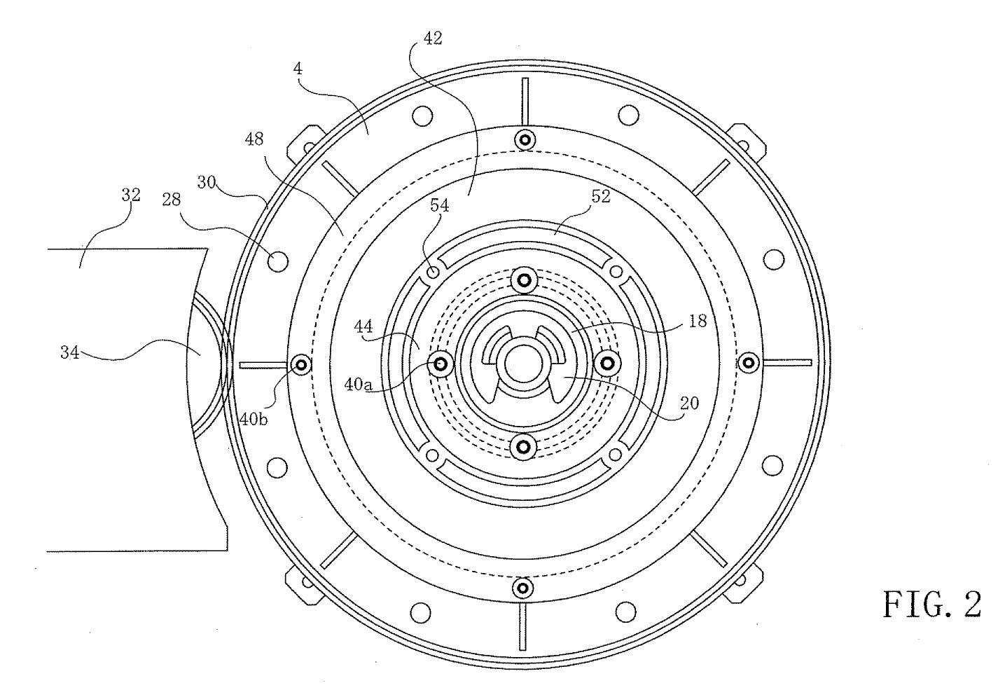

FIG. 3 is a longitudinal cross-sectional view of the rotary table of FIG. 1 used as a manually driven rotary table.

### BEST MODE FOR CARRYING OUT THE INVENTION

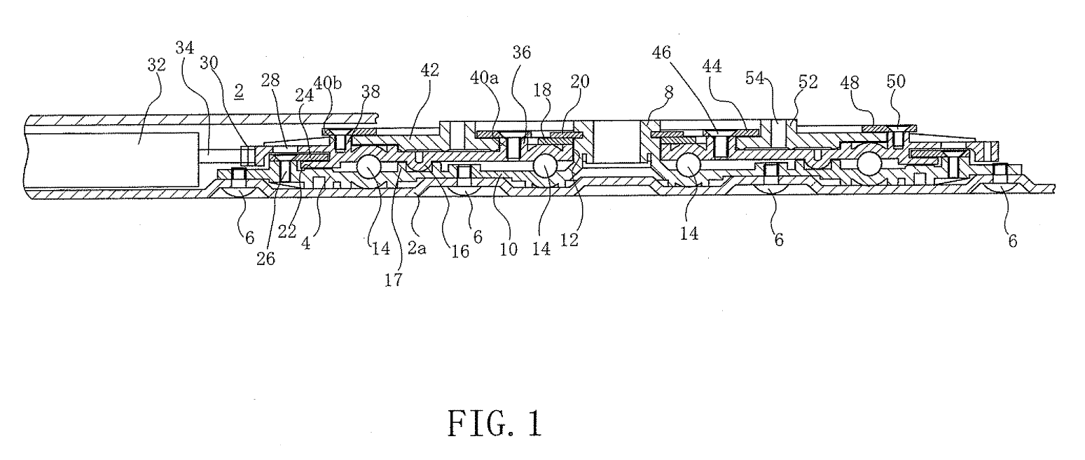

A rotary table according to an embodiment of the present invention is for rotating a television receiver as an article to be rotated. Needless to say, it can be used for rotating anything other than a television receiver. As shown in FIG. 1, the rotary table includes a case 2, which is formed in the shape of a flat disc. A base plate 4 is attached to a bottom plate 2a of the case 2. The base plate 4 is formed in the shape of disc, which is size smaller than the case 2. The base plate 4 is secured to the bottom plate 2a with bolts 6 at a plurality of spaced-apart points along the periphery of the base plate 4. A columnar rotation spindle 8 extends upward from the center of the base plate 4. The rotation spindle 8 is perpendicular to the base plate 4.
A first rotating plate 10 is disposed on a top surface of the base plate 4. The first rotating plate 10 is also disc-shaped, and its diameter is chosen to be slightly smaller than that of the base plate 4. A circular insertion hole 12 is formed at the center of the first rotating plate 10. The spindle 8 extends through the insertion hole 12, so that the first rotating plate 10 is rotatable about the rotation spindle 8. In order for the first rotating plate 10 to rotate smoothly, a plurality of rolling members, e.g. balls 14, are arranged, being spaced from each other, in two loops concentric with the rotation spindle 8. Also, for the same purpose, an annular guide 16 rising toward the base plate 4 is formed in a portion between the two loops of the bottom surface of the first rotating plate 10. Annular guide rails 17 are formed in the top surface of the base plate 4 to engage with the guide 16.

A disc 18 is fitted over the spindle 8 to contact the top surface of the first rotating plate 10. Also, an E-ring 20 is fitted to engage with the spindle 8 and contact the disc 18. An annular groove 22 is formed to radially extend into the peripheral surface of the first rotating plate 10, and a ring-shaped member 24 extends into the groove 22. The ring-shaped member 24 is secured to the base plate 4 with bolts 26. A reference numeral 28 denotes windows formed in the first rotating plate 10 through which the bolts 26 are secured. As described, the first rotating plate 10 is secured to the base plate 4 by both its top and bottom surfaces, and therefore is prevented from vibrating up and down.

A spar gear 30 is formed along the entire outer periphery of the first rotating plate 10, which acts as a driving force transmitting part. The gear 30 engages with a gear 34 of a driving power source 32 disposed within the case 2. The driving power source 32 includes a motor (not shown), for example, and also a power transmission mechanism, including the gear 34, which transmits driving force from the motor to the gear 34 with a predetermined torque. Accordingly, when the driving power source 32 causes the gear 34 to rotate, the first rotating plate 10 rotates about the spindle 8.

An annular protrusion 36 concentric with the spindle 8 is formed to extend upward from the top surface of the first rotating plate 10. An annular protrusion 38 concentric with the spindle 8 is formed, being spaced outward of the annular protrusion 36. Thus, the first rotating plate 10 is stepped in the portion between the protrusions 36 and 38. The protrusions 36 and 38 extend upward to the same height. First attachment parts 40a are formed in the annular protrusion 36 at intervals of 90 degrees. Similarly, first attachment parts 40b are formed in the annular protrusion 38 at intervals of 90 degrees. The first attachment parts 40a and 40b may be in the form of threaded holes with which bolts can engage.

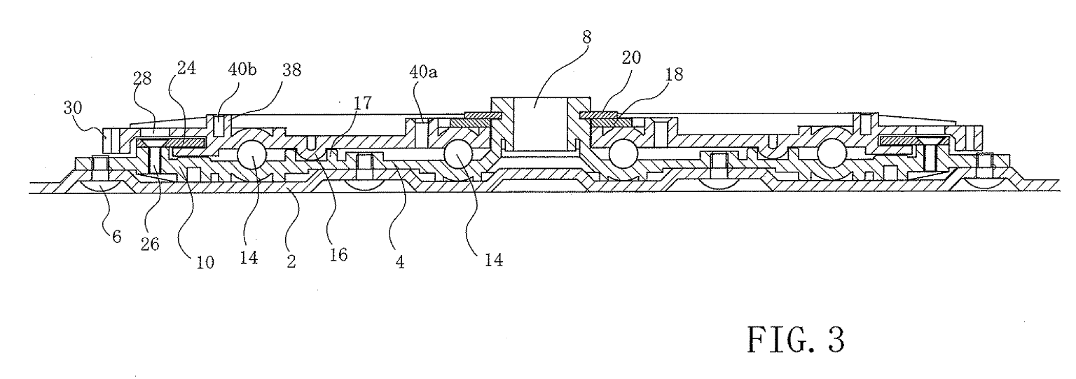

A second rotating plate 42 is disposed on the top surface portion of the first rotating plate 10 between the protrusions 36 and 38. The second rotating plate 42 is an annular member disposed about the spindle 8 concentrically with the spindle 8. An annular pressing plate 44 is disposed on the protrusion 36 concentrically with the spindle 8. An outer peripheral portion of the pressing plate 44 is in contact with the upper surface of an inner peripheral portion of the second rotating plate 42. The pressing plate 44 is secured to the first attachment parts 40a by means of bolts 46. An annular pressing plate 48 is disposed on the protrusion 38 concentrically with the spindle 8. An inner peripheral portion of the pressing plate 48 is in contact with the upper surface of an outer peripheral portion of the second rotating plate 42. The pressing plate 48 is secured to the first attachment parts 40b by means of bolts 50. Thus, the second rotating plate 42 can be detached from the first rotating plate 10 by loosening the bolts 46 and 50. Thus, the second rotating plate 42 can be attached to and detached from the first rotating plate 10 as occasion demands. The rotary table with the second rotating plate 42 removed is shown in FIG. 3. With the second rotating plate 42 removed, an article to be rotated, e.g. a television receiver, can be attached to the first rotating plate 10 using the first attachment parts 40a and 40b. With second rotating plate 42 attached to the first rotating plate 10, the pressure applied through the bolts 46 and 50 is applied to the pressing plates 44 and 48, so that the second rotating plate 42 is pressed against the first rotating plate 10, whereby the first and second rotating plates 10 and 42 are friction-coupled with each other. When force greater than the friction force acting between the first and second rotating plates 10 and 42 is applied about the spindle 8, the second rotating plate 42 slips relative to the first rotating plate 10.

An upward protruding annular protrusion 52 is formed on the top surface of the second rotating plate 42. The protrusion 52 includes plural, for example, four, second attachment parts 54 formed at intervals of. 90 degrees. The second attachment parts 54 are also threaded holes with which bolts can engage as in the case of the first attachment parts 40a and 40b. By means of the second attachment parts 54, an article to be rotated, e.g. a television receiver, can be attached to the second rotating plate 42.

For using the rotary table with the above-described arrangement as a mechanically driven rotary table, the spar gear 30 of the first rotating plate 10 is brought into engagement with the spar gear 34 of the driving power source 32, and the second rotating plate 42 is attached to the first rotating plate 10. Then, a television receiver is secured to the second attachment parts 54. As the driving power source 32 is activated, the spar gear 34 rotates, causing the first rotating plate 10 to rotate. Since the first rotating plate 10 is friction-coupled to the second rotating plate 42, the rotation of the first rotating plate 10 causes the second rotating plate 42 to rotate, too, which, in turn, so rotates the television receiver. If a child, for example, is sandwiched between the television receiver and a wall while the television receiver is rotating, force greater than the friction force is exerted to the second rotating plate 42, causing the second rotating plate 42 to slip with respect to the first rotating plate 10. Thus, the television receiver does not rotate further, and the child is prevented from being injured.

In order to use the rotary table as a manually driven rotary table, the second rotating plate 42 is detached from the first rotating plate 10, and a television receiver is secured to the first attachment parts 40a and 40b, which have been used to secure the second rotating plate 42. When force is applied to the television receiver, the first rotating plate 10 rotates, directing the television receiver face to a desired direction.

The described rotary table can advantageously be used either as a manually driven rotary table or a mechanically driven rotary table. In addition, when it is used as a mechanically driven rotary table, the second rotating plate 42 slips when large force is exerted to the television receiver, so as to prevent the television receiver from rotating further, whereby safety can be secured. When the rotary table is used as a manually driven rotary table, the driving power source 32 is not necessary, and therefore a case smaller than the case 2 can be used. When the rotary table is used as a mechanically driven rotary table, it is necessary to attach the second rotating plate 42 to the first rotating plate 10. Since this attachment is done by means of the first attachment parts 40a and 40b which are used to mount the television receiver to the rotary table used as a manually driven rotary table, no separate attachment parts need be provided for the first rotating plate 10 for the purpose of attaching the second rotating plate 42 thereto. This can simplify the structure of the rotary table. Further, since the attachment of the second rotating plate 42 to the first rotating plate 10 in such a manner as to permit the second rotating plate 10 to slip is achieved by pressing the second rotating plate 42 against the first rotating plate 10 by means of the pressing members 44 and 48, the arrangement for permitting such slippage can be simple. Since the second rotating plate 42 is mounted on the step between the protrusions 36 and 38 of the first rotating plate 10, the rotary table either when used as a mechanically driven rotary table or as a manually driven one has almost the same height.

The invention has been described by means of an embodiment for rotating a television receiver, but it is not limited to it, and the rotary table can be used for rotating any other articles. Also, according to the described embodiment, the balls 14, the guide 16 and the guide rails 17 are used for rotatably supporting the first rotating plate 10 with respect to the base plate 4, but any known rotatable supporting arrangements can be employed instead.

1. A rotary table comprising:
a planar base plate;
a first rotating plate carried on said base plate in such a manner as to be rotatable about an axis extending perpendicular to said base plate, said first rotating plate including a driving force transmitting part through which driving force for rotating said first rotating plate about said axis is transmitted, said first rotating plate including further a first attachment part for attachment to an article to be rotated; and
a second rotating plate detachably attached to said first rotating plate in such a manner that, when force greater than a predetermined magnitude is exerted to said second rotating plate, said second rotating plate can rotate relative to said first rotating plate about said axis, said second rotating plate including a second attachment part for attachment to said article to be rotated.

2. The rotary table according to claim 1, wherein the attachment of said second rotating plate to said first rotating plate is done by placing said second rotating plate on a top surface of said first rotating plate and detachably fixing, to said first rotating plate, a pressing member extending from said first rotating plate onto the peripheral portion of said second rotating plate.

3. The rotary table according to claim 2, wherein said second rotating plate is placed in a recessed portion formed in the top surface of said first rotating plate.

4. The rotary table according to claim 2, wherein said first attachment part is coplanar with said second rotating plate, and said pressing member is attached to said first attachment part.
